(19) United States
(12) Patent Application Publication
(10) Pub. No.: US 2003/0072149 A1
(43) Pub. Date: Apr. 17, 2003

(54) Flicker

(76) Inventor: Bernadette Ann Martinez, Albuquerque, NM (US)

Correspondence Address: BERNADETTE A. DELGADO, 305 SAN TOMAS LANE S.W., ALBUQUERQUE, NM, 87121, US

(21) Appl. No.: 09/978,225

(22) Filed: Oct. 16, 2001

(51) Int. Cl. F21L 2/00

(52) U.S. Cl. 362/157; 362/208

(57) ABSTRACT

The Flicker is a portable battery operated, hand held light. This product is unique by the cover it contains. It allows light to shine through a transparent cover that simulates a small flickering fire. The Flicker can be used with or without the plastic slides for numerous looks. The performer returns their appreciation to the audience by performing to greater heights. In addition The Flicker is distinctive by the label which includes the name of the performer, or event and year. Many consumers would find this product appealing and may like to start a collection from several events they have attended therefore making The Flicker unique and collectable memorabilia.

### SPECIFICATION

The design of The Flicker calls for plastic, metal and a flickering light bulb as its major components.

The plastic casing is an elongated octagon shape, which would be produced from high impact injection-molded acrylic and PVC plastic. The Flicker will stand 3 ½ inches in height and 5 inches in diameter and be produced in a variety of colors. The casing can be modified for specification to produce The Flicker for correctness. The exterior would have an on/off switch located to the right of the casing. In addition the casing would be decorated with the name of the performer, event and include year for collectable purposes.

The interior will have a cavity to carry two AA batteries.

The top of The Flicker will contain a small screwing cylindrical housing to hold a flickering light bulb. This can be made from a stainless steel product, such as 303 and 304 stainless steel. The Flicker will also be equipped with a transparent plastic cover which will snap on and off easily to replace the flickering light bulb and plastic slides, not only for uniqueness, but particularly for safety. The cover will be made in an array of colors to accompany the casing and will be made of the same type of high impact injection-molded acrylic and PVC plastic. The inside of the cover will have grooves from the top of the cover to the bottom of the cover. These grooves will allow thin sheets of plastic to slide in and out easily. The plastic slides will be designed with cut out shapes, such as stars, stripes, circles, numbers, letters, etc. This will allow the flickering light to shine through. The Flicker can be used with or without the plastic slides to produce numerous appearances. Also, the plastic slides are interchangeable.

### CROSS-REFERENCE TO RELATED APPLICATIONS

Not Applicable

### STATEMENT REGARDING FEDERALY SPONSORED RESEARCH OR DEVELOPMENT

Not Applicable

### REFERENCE TO MICROFICHE APPENDIX

Not Applicable

### BACKGROUND OF THE INVENTION

The Classification Definition or subject matter could place The Flicker in the category of a hand held lighting apparatus, such as a flashlight.

The background of my idea came to light upon viewing a concert on television. In observing half of million concert-goers showing their support to the performer, by holding up cigarette lighters and candles, I realized the potential danger that could derive from this type of support. Not only to one person, but many supporters could potentially be blistered or obtain a serious burn to the body, hair or clothing.

### BRIEF SUMMARY OF THE INVENTION

The summary addresses the background of The Flicker conception and the problems it is designed to ease or eliminate.

During a concert, or performance audience members often hold up cigarette lighters and turn them on, producing lights that can be seen by the performers on stage. These lights allow the audience members to show their support for performers and can inspire them to greater heights. Burning the lighters fuel for a long period of time, however, causes the lighter to become hot to the touch and increases the possibility of a painful blister or bum, and maybe even a fire to ones clothing or hair.

The new idea of The Flicker would provide a convenient easy-to-use light that would allow audience members to provide support to a performer without suffering bums. It would be easy to carry from one location to another and could be used as a souvenir.

The Flicker could be marketed to consumers 4 years of age and older.

Because of the problems The Flicker addresses and solves through its application, consumers will find such an invention attractive and appealing.

### BRIEF DESCRIPTION OF THE SEVERAL VIEWS OF THE DRAWING

Not Applicable

### DETAILED DESCRIPTION OF THE INVENTION

The Flicker is an innovating idea that can be vital to future eventgoers. It brings an exciting new way for an audience to show their support to a performer in a safe and fashionable form.

The Flicker is a portable hand held light that can be used at any function or event. Previously at events, such as concerts, audiences would use simple cigarette lighters to show the entertainer that the performance was well received. The audience may not have realized the potential danger brought to them and others by using that type of item. In using The Flicker all these dangers can be avoided and still show the support intended.

The Flicker again, calls for plastic, metal and a flickering light bulb as its major components. These materials are available in the market and are easily obtainable. The injection-molded acrylic and PVC plastics are durable, light weight and have high tensile strength. Injection-molding plastics can be produced in mass production which encludes speed and the ability to simultaneously mold multiple parts. Type 303 and 304 stainless steel have common characteristics of high strength and good corrosion resistance. The flickering light bulb is on the market for immediate retail.

What I claim as my invention is:

1. A safe new idea for audience members to show their support to a performer/s, keeping them from potential burns to the skin, hair and clothing.
